(19) United States
(12) Patent Application Publication
(10) Pub. No.: US 2008/0277104 A1
(43) Pub. Date: Nov. 13, 2008

(54) Al-AlN composite material, related manufacturing method and heat exchanger using such composite material

(75) Inventors: Yuuichi Aoki, Chita-gun (JP); Yukihisa Takeuchi, Chita-gun (JP); Yasumasa Hagiwara, Kariya-city (JP); Eiichi Torigoe, Anjo-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/149,899

(22) Filed: May 9, 2008

(30) Foreign Application Priority Data
May 11, 2007 (JP) 2007-127084

(51) Int. Cl. F28D 21/00; B22D 23/00; B32B 15/04

(52) U.S. Cl. 165/104.33; 164/97; 428/627

(57) ABSTRACT

An Al—AlN composite material, a heat exchanger and a related manufacturing method are disclosed. The Al—AlN composite material aluminum is manufactured by melting aluminum to allow a layer of melted aluminum to flow in an area over one surface of an AlN plate under an inactive gas atmosphere after which the layer of melted aluminum is solidified to form an Al plate bonded to the AlN plate. The heat exchanger includes the Al—AlN composite material forming at least part of a cooling medium flow passage with the AlN plate held in thermal contact with a heating body. The manufacturing method comprises melting aluminum to allow a layer of melted aluminum to flow in an area over one surface of an AlN plate under inactive gas atmosphere, and solidifying the layer of melted aluminum to form the Al plate bonded to the AlN plate.

### CROSS REFERENCE TO RELATED APPLICATIONS

This application is related to Japanese Patent Application No. 2007-127084, filed on May 11, 2007, the content of which is hereby incorporated by reference.

### BACKGROUND OF THE INVENTION

1. Technical Field of the Invention

The present invention relates to an Al—AlN composite material composed of an Al plate and an AlN plate bonded thereto, a related manufacturing method and a heat exchanger using such an Al—AlN composite material.

2. Description of the Related Art

A power converter device, such as an inverter, a converter or the like, includes a semiconductor module that is usually cooled with a cooling structure using a cooling unit. As shown in FIG. 20, the cooling unit 6 usually includes a cooling tube 61 placed in contact with a heat-dissipating surface of the semiconductor module 7 via an insulating plate 19. That is, the heat-dissipating surface of the semiconductor module 7 takes the form of an electrode plate 73 and the cooling tube 61 is made of aluminum. Thus, the insulating plate 19 needs to be placed between the electrode plate 73 and the cooling tube 61.

Further, if air intervenes between the insulating plate 19 and the semiconductor module 7 and between the insulating plate 19 and the cooling tube 61, a drop occurs in heat transfer efficiency. To address such an issue, grease layers 11 are provided between the insulating plate 19 and the semiconductor module 7 and between the insulating plate 19 and the cooling tube 61, respectively, with a view to preventing the presence of air.

However, if the grease layers 11 are located on both surfaces of the insulating plate 19, the grease layers 11 cause both surfaces of the insulating plate 19 to have thermal resistances. That is, increased thermal resistances occur in two areas between the insulating plate 19 and the semiconductor module 7 and between the insulating plate 19 and the cooling tube 61, respectively, resulting in a drop in heat transfer efficiency.

To address such an issue, the cooling structure is arranged to have a structure in which the grease layer 11 is removed from one of the surfaces of the insulating plate 19 to decrease thermal resistance between the semiconductor module 7 and the cooling tube 61 to provide improved cooling efficiency.

In connection to the above thermal resistances, U.S. Pat. No. 6,037,066 (corresponding in part to Japanese Patent Application Publication No. 10-287934) discloses an inclination function material including a composite material composed of a metallic layer and a ceramics layer unitarily fixed to the metallic layer. It is conceived that intervening such a composite material between the semiconductor module and the cooling tube enables a reduction in thermal resistance between these component parts with establishment of electrical insulating property.

However, a difficulty arises in manufacturing such an inclination function material in actual practice.

### SUMMARY OF THE INVENTION

The present invention has been completed with a view to addressing the above issues and has an object to provide an Al—AlN composite material composed of an Al plate and an AlN plate bonded thereto with combined effects of electrically insulating property and heat conductivity, a related manufacturing method and a heat exchanger using such an Al—AlN composite material.

To achieve the above object, a first aspect of the present invention provides an Al—AlN composite material comprising an Al plate made of aluminum, and an AlN plate made of aluminum nitride. Aluminum is melted and flows over one surface of the AlN plate under inactive gas atmosphere after which melted aluminum is solidified to form the Al plate bonded to the AlN plate.

The Al—AlN composite material is composed of the Al plate and the AlN plate bonded to one surface of the Al plate and can have combined effects of electrically insulating property and heat conductivity. That is, the Al—AlN composite material can ensure electrically insulating property due to the presence of the AlN plate. In addition, the Al plate and the AlN plate are directly bonded to each other, thereby enabling a reduction in thermal resistance between the Al plate and the AlN plate while increasing heat conductivity of the Al—AlN composite material.

Further, aluminum is melted to spread over one surface of the AlN plate under inactive gas atmosphere after which melted aluminum is solidified to form the Al plate bonded to the AlN plate, thereby making it possible to easily manufacture the Al—AlN composite material.

As set forth above, the present invention enables the provision of the Al—AlN composite material with combined effects of electrically insulating property and heat conductivity.

A second aspect of the present invention provides an Al—AlN composite material comprising an Al plate made of aluminum and having one surface formed with heat-dissipating configurations, and an AlN plate made of aluminum nitride and bonded to the other surface of the Al plate.

With the second aspect of the present invention, the Al—AlN composite material includes the Al plate that has one surface formed with the heat-dissipating configurations. Therefore, using such an Al—AlN composite material as part of a heat exchanger results in an increased contact surface area with heat medium, enabling improved heat exchange efficiency to be obtained.

Further, like the Al—AlN composite material of the first aspect of the present invention, the Al—AlN composite material includes the Al plate and the AlN plate bonded to one surface of the Al plate, enabling combined effects of electrically insulating property and heat conductivity to be obtained.

As set forth above, the second aspect of the present invention enables the provision of the Al—AlN composite material having the combined effects of electrically insulating property and heat conductivity.

A third aspect of the present invention provides a heat exchanger including the Al—AlN composite material forming at least a part of the heat exchanger wherein the AlN plate is held in thermal contact with a heating body.

With the third aspect of the present invention, the heat exchanger can have excellent electrically insulating property and heat conductivity between the heating body and the heat exchanger.

That is, the third aspect of the present invention enables the provision of the heat exchanger having the combined effects of electrically insulating property and heat conductivity.

A fourth aspect of the present invention provides a method of manufacturing an Al—AlN composite material, the method comprising melting aluminum in an area over one surface of an AlN plate under inactive gas atmosphere, flowing melted aluminum in the area over the surface of the AlN plate under inactive gas atmosphere, placing a forming die on a layer of melted aluminum present on the surface of the AlN plate, and solidifying the layer of melted aluminum to form an Al plate bonded to the AlN plate.

With the method of manufacturing an Al—AlN composite material mentioned above, melting aluminum in the area over the surface of the AlN plate under inactive gas atmosphere and causing melted aluminum to flow in the area over the one surface of the AlN plate after which the layer of melted aluminum is solidified to form the Al—AlN composite material, enabling the Al—AlN composite material to be easily manufactured.

In addition, the Al—AlN composite material, obtained by the manufacturing method described above, includes the Al plate and the AlN plate bonded to one surface of the Al plate, resulting in combined effects of electrically insulating property and heat conductivity.

As set forth above, the fourth aspect of the present invention can provide the method of manufacturing the Al—AlN composite material having the combined effects of electrically insulating property and heat conductivity.

In the first and fourth aspects of the present invention, examples of inactive gas may include gas such as, for instance, nitrogen gas, argon gas or the like. In addition, inactive gas, used in the inactive gas atmosphere, may have a purity of, for instance, 99% or more.

Further, in the Al—AlN composite material of the first aspect of the present invention, the Al plate may preferably have one surface formed with heat-dissipating configurations in opposition to the other surface of the Al plate bonded to the AlN plate.

In this case, using the Al—AlN composite material as part of a heat exchanger enables an increase in contact surface area with heat medium, enabling improved heat exchange efficiency to be obtained.

With the Al—AlN composite material of the first or second aspect of the present invention, the Al plate may preferably have an outer circumferential portion covering an end of the AlN plate.

With such a structure, the AlN plate is retained with the Al plate, enabling the prevention of damage to the AlN plate. In addition, even if a crack occurs in the AlN plate, the Al plate present on the circumference of the AlN plate avoids the expansion of the crack, thereby suppressing the occurrence of degradation in electrically insulating property.

With the third aspect of the present invention, the heat exchanger may preferably include a coolant medium flow passage admitting a flow of coolant medium available to perform heat exchange with the heating body, wherein the Al plate forms at least a part of the coolant medium flow passage.

With such a structure, the Al plate can be held in direct contact with cooling medium passing through the coolant medium flow passage, resulting in improved heat exchange efficiency between the Al—AlN composite material and cooling medium. As a result, the heat exchanger can have improved heat exchange efficiency between the heating body and cooling medium.

Further, the heating body may preferably include an electronic component part.

In this case, the Al—AlN composite material can have improved heat exchange efficiency between the electronic component part and cooling medium with electrically insulating property ensured between the electronic component part and cooling medium.

The heat exchanger may preferably comprise a cooling unit for cooling a semiconductor module forming an electric power converter device.

In this case, the heat exchanger can have improved heat exchange efficiency between the semiconductor module and cooling medium with an increase in electrically insulating property ensured between the semiconductor module and cooling medium.

With the method of manufacturing the Al—AlN composite material according to the fourth aspect of the present invention, the forming die may preferably have one surface, facing the AlN plate, which is formed with a corrugated surface, whereby when the forming die is placed on the layer of melted aluminum present on the one surface of the AlN plate, the Al plate is formed with heat-dissipating configurations in conformity with the corrugated surface of the forming die. As used herein, the term “heat-dissipating configurations” refers to a structure such as fins formed in corrugated or protruding shapes. This similarly applies to the heat-dissipating configurations in the second aspect of the present invention.

Such a manufacturing method enables the provision of the heat-dissipating configurations formed on the Al plate in an easy fashion. Using the Al—AlN composite material, obtained by such a manufacturing method, as part of a heat exchanger enables an increase in contact surface area with heat medium, making it possible to provide improved heat exchange efficiency.

A fifth aspect of the present invention provides a heat exchanger for cooling a heating body, comprising a cooling tube, and an Al—AlN composite material interposed between the heating body and the cooling tube to initiate a heat exchange between the heating body and the cooling tube, wherein the Al—AlN composite material comprises an Al plate, made of aluminum and having one surface formed with a heat dissipating surface associated with the cooling tube, and an AlN plate made of aluminum nitride and bonded to the other surface of the Al plate upon melting aluminum on the AlN plate under inactive gas atmosphere after which melted aluminum is solidified.

### BRIEF DESCRIPTION OF THE DRAWINGS

FIGS. 1A and 1B are views illustrating initial steps of a method of manufacturing an Al plate-AlN composite material of a first embodiment according to the present invention.

FIGS. 2A and 2B are views illustrating subsequent steps of the method of manufacturing the Al plate-AlN composite material of the first embodiment according to the present invention.

FIG. 3 is a cross-sectional illustrative view of the Al plate-AlN composite material resulting from the manufacturing method shown in FIGS. 1A and 1B and FIGS. 2A and 2B.

FIG. 4A is a view illustrating a boundary between aluminum before it is melted and an AlN plate and FIG. 4B is a view illustrating a boundary between aluminum after it is melted and the AlN plate in the first embodiment shown in FIGS. 1A and 1B and FIGS. 2A and 2B.

FIG. 5 is a view illustrating a cooling structure of a semiconductor module incorporating the Al plate-AlN composite material of the first embodiment.

FIG. 6 is a cross sectional view illustrating a bonding structure between a cooling tube and the Al plate-AlN composite material of the first embodiment.

FIG. 7 is a typical view showing a comparative cooling structure of a semiconductor module of the related art.

FIG. 8 is another typical view showing a cooling structure of the semiconductor module of a third embodiment according to the present invention.

FIG. 9 is a typical view showing a cooling structure of a semiconductor module of a third embodiment according to the present invention.

FIG. 10 is a plan view illustrating an Al—AlN composite material of a third embodiment according to the present invention and an electrode plate of a semiconductor module.

FIG. 11 is a typical view showing a cooling structure of a semiconductor module of a fourth embodiment according to the present invention.

FIGS. 12A and 12B are views illustrating initial steps of a method of manufacturing an Al plate-AlN composite material of a fifth embodiment according to the present invention.

FIGS. 13A and 13B are views illustrating subsequent steps of the method of manufacturing the Al plate-AlN composite material of the fifth embodiment according to the present invention.

FIGS. 14A and 14B are views illustrating a further subsequent step of the method of manufacturing the Al plate-AlN composite material of the fifth embodiment according to the present invention.

FIG. 15 is a typical view showing a cooling structure of a semiconductor module of the fifth embodiment according to the present invention.

FIGS. 16A and 16B are views illustrating initial steps of a method of manufacturing an Al plate-AlN composite material of a sixth embodiment according to the present invention.

FIGS. 17A and 17B are views illustrating subsequent steps of the method of manufacturing the Al plate-AlN composite material of the sixth embodiment according to the present invention.

FIGS. 18A and 18B are views illustrating a further subsequent step of the method of manufacturing the Al plate-AlN composite material of the sixth embodiment according to the present invention.

FIG. 19 is a typical view showing a cooling structure of a semiconductor module of the sixth embodiment according to the present invention.

FIG. 20 is a view showing a cooling structure of a semiconductor module of the related art.

### DETAILED DESCRIPTION OF PREFERRED EMBODIMENTS

Now, Al—AlN composite materials, related manufacturing methods and heat exchangers of various embodiments according to the present invention will be described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views.

### EMBODIMENTS

### Embodiment 1

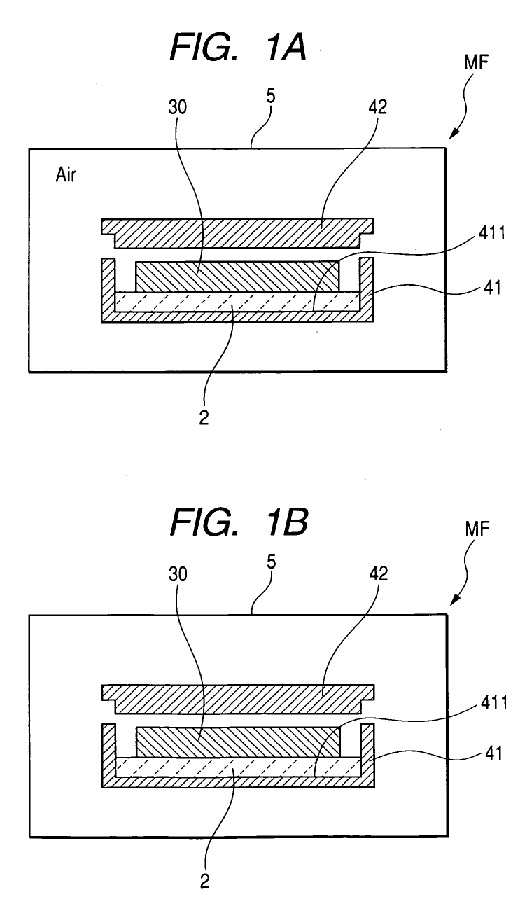

Now, an Al—AlN composite material of one embodiment according to the present invention, a method of manufacturing the same and a heat exchanger employing such composite material will be described below in detail with reference to FIGS. 1A and 1B to FIGS. 4A and 4B, and FIGS. 5 and 6 of the accompanying drawings.

As shown in FIGS. 1A and 1B, FIGS. 2A and 2B and FIG. 3, the Al—AlN composite material 1 of the present embodiment is manufactured by melting aluminum to flow onto one surface of an AlN plate 2, made of aluminum nitride, under an inert gas atmosphere after which melted aluminum is solidified to form an Al plate 3, made of aluminum, which is bonded to the AlN plate 3.

Hereunder, the method of manufacturing the Al—AlN composite material 1 of the present embodiment will be described below in detail.

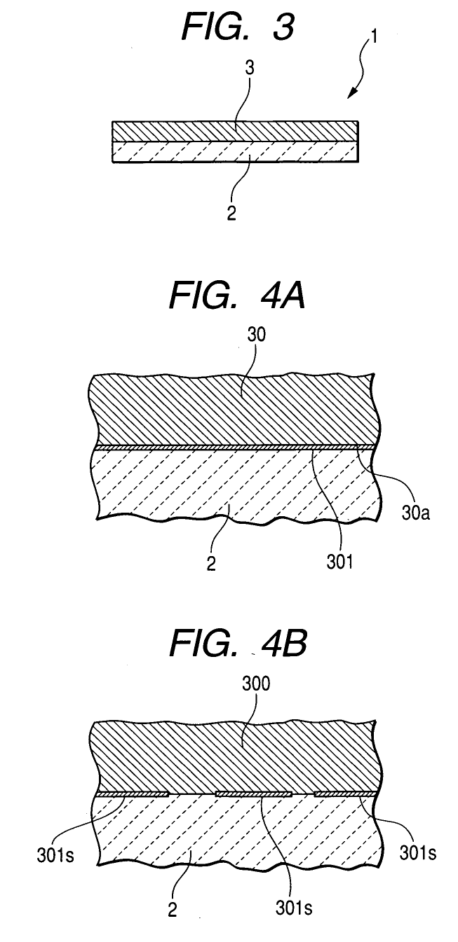

That is, first, as shown in FIG. 1A, a melting furnace MF having a chamber 5 provided with a lower die 41 is prepared. Then, the AlN plate 2 is placed in a cavity 411 of the lower die 41 and a plate member 30 of aluminum is placed on the AlN plate 2. The plate member 30 of aluminum has a greater thickness than that of the Al plate 3 (see FIG. 3) with a lengthwise and crosswise shape smaller than that of the Al plate 3 to be obtained.

As shown in FIG. 1B, next, the chamber 5 is evacuated to discharge air containing oxygen to the outside.

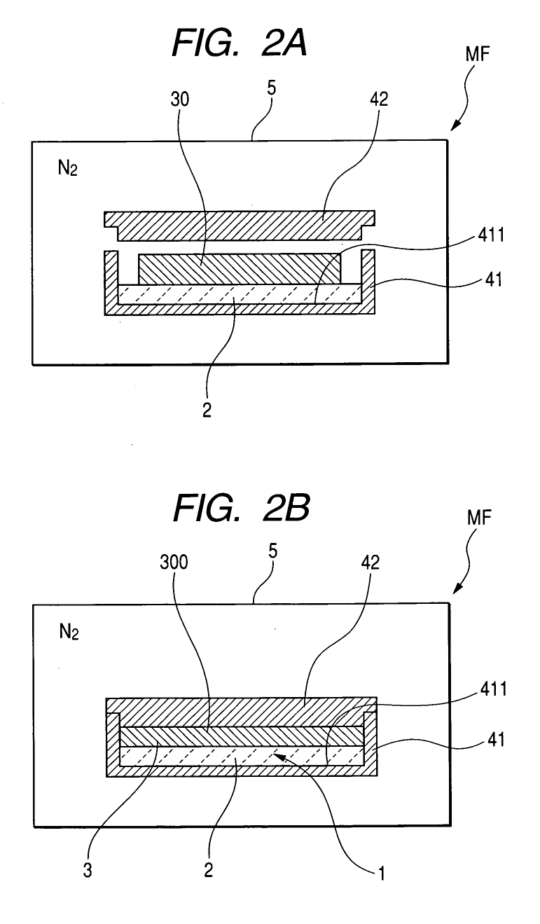

As shown in FIG. 2A, a stream of nitrogen (N₂) gas is then introduced into the chamber 5, thereby forming a nitrogen atmosphere therein. Nitrogen (N₂) present in such a nitrogen atmosphere has a purity of, for instance, 99% or more.

As shown in FIG. 2B, subsequently, the chamber 5 is heated causing the plate member 3 of aluminum to be melted. This allows melted aluminum 300, resulting from melted plate member 30, to spread in an area over a surface of the AlN plate 2 in the cavity 411 of the lower die 41.

As shown in FIG. 4A, further, the Al plate 30 has one surface 30a, facing the AlN plate 2, which is formed with an oxide film 301 on a stage before it is melted. However, when the plate member 30 is melted to spread in the area over the surface of the AlN plate 2, the oxide film 301 is broken down into film in multiple segments 301a as shown in FIG. 4B. This results in a consequence of causing melted aluminum 300 to be brought into tight contact with the surface of the AlN plate 2.

When this takes place, further, an upper die 42 is moved closer to the lower die 41 into mating engagement therewith to press melted aluminum 300, thereby shaping the same into a plate-like configuration as shown in FIG. 2B.

Subsequently, the chamber 5 is cooled, thereby cooling the AlN plate 2 and melted aluminum 300. This allows melted aluminum 300 to be solidified into the Al plate 3, which is bonded to the surface of the AlN plate 2.

As shown in FIG. 3, then, the Al—AlN composite material 1, composed of the AlN plate 2 and the Al plate 3 bonded to each other, is taken out of the lower die 41.

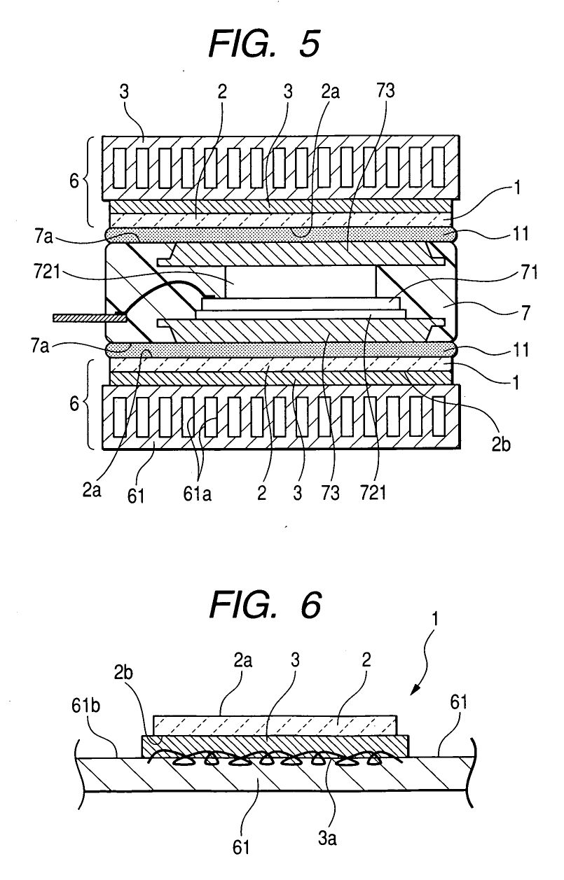

The Al—AlN composite material 1 obtained in such a way discussed above is used as part of a heat exchanger. With the present embodiment, the heat exchanger includes a cooling unit 6 for cooling a semiconductor module 7 forming a power converter device as shown in FIG. 5.

As shown in FIG. 6, in particular, the Al—AlN composite material 1 is bonded to a surface of a cooling tube 61 formed with a plurality of coolant flow passages 61a to cool the cooling unit 6. The Al—AlN composite material 1 has the Al plate 3 whose surface 3a is bonded to a surface 61b of the cooling tube 61 by brazing. In addition, the Al—AlN composite material 1 has the AlN plate 2 whose surface 2a is held in abutting contact with a main surface 7a of the semiconductor module 7 via a layer of grease 11 and the other surface 2b directly bonded to the Al plate 3.

The semiconductor module 7 incorporates therein a semiconductor element 71, such as an IGBT or the like acting as a heating body, which is sandwiched between a pair of electrode plates 73, made of Cu, via spacers 721 and a soldering 722. The electrode plates 73 are exposed to both surfaces of the semiconductor module 7.

The Al—AlN composite material 1 is held in tight contact with the electrode plate 73 of the semiconductor module 7 via the layer of grease 11. In addition, the Al—AlN composite material 1 is arranged such that the AlN plate 2 has one surface 2a facing the semiconductor module 7 and the Al plate 3 has one surface 3a bonded to the surface of the cooling tube 61 by brazing.

As shown in FIG. 5, further, both of main surfaces of the semiconductor module 7 are sandwiched between the cooling tubes 61. That is, the pair of electrode plates 73 are placed on both main surfaces of the semiconductor module 7 with the layer of grease 11, the Al—AlN composite material 1 and the cooling tube 61 being stacked in sequence.

The Al—AlN composite material 1 of the present embodiment, the method of manufacturing the same and the heat exchanger employing such a composite material have various advantageous effects that will be described below.

The Al—AlN composite material 1 is comprised of the Al plate 3 and the AlN plate 2 bonded to one surface of the Al plate 3, thereby having a combined effect of electrically insulating property and thermal conductivity. That is, the Al—AlN composite material 1 is associated with the AlN plate 2 with which electrically insulating property can be ensured. In addition, the Al plate 3 and the AlN plate 2 are directly bonded to each other, enabling an increase in thermal conductivity between the Al plate 3 and the AlN plate 2. This enables the Al—AlN composite material 1 to have improved heat-conducting rate.

Further, the Al—AlN composite material 1 is obtained upon melting aluminum on one surface of the AlN plate 2 under inactive gas atmosphere (under nitrogen gas atmosphere) to cause melted aluminum to flow thereon in a layer and subsequently solidifying the aluminum layer, making it possible to easily manufacture the Al—AlN composite material 1.

Furthermore, the cooling unit 6 includes the Al—AlN composite material 1 placed between the semiconductor module 7 and the cooling tube 61. This allows the cooling unit 6 to ensure increased electrically insulating property and heat conductivity between the semiconductor module 7 and the cooling unit 6.

From the foregoing, it will be apparent that the present embodiment can provide an Al—AlN composite material with the combined effect of electrically insulating property and heat conductivity, a related manufacturing method, and a cooling unit ensured with increased electrically insulating property and heat conductivity between a semiconductor module and the cooling unit.

### Embodiment 2

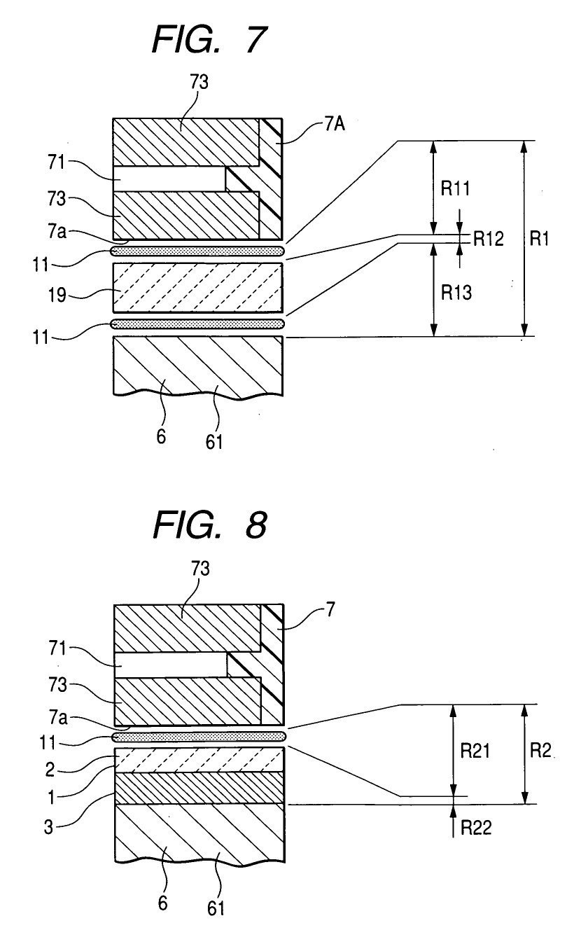

A cooling structure of a semiconductor module of a second embodiment according to the present invention will be described below with reference to FIGS. 7 and 8, in which an improving effect of a cooling efficiency of the Al—AlN composite material 1 is verified.

FIG. 7 shows a comparative cooling structure corresponding to the cooling structure of the related art shown in FIG. 20. With the comparative cooling structure shown in FIG. 7, the cooling tube 61 is placed on the main surface of the semiconductor module 7 via the grease layer 11, an insulating plate 19 composed of SiN, and the grease layer 11.

In contrast, a cooling structure implementing the present invention is prepared which is shown in FIG. 8. With the cooling structure shown in FIG. 8, the Al—AlN composite material 1 is bonded to the cooling tube 61 by brazing to form a unitary structure, which in turn is placed on the main surface 7a of the semiconductor module 7 via the grease layer 11. This corresponds to the cooling structure for the semiconductor module shown in the first embodiment.

FIGS. 7 and 8 are views showing frame formats of various component parts, respectively, with the semiconductor module 7 taking the same structure as that shown in the first embodiment. In these views, only the cooling tube 6, placed on one main surface 7a of the semiconductor module 7 with the other main surface of the semiconductor module 7 and associated component parts being omitted for simplicity of illustration.

Tests were conducted upon admitting coolant medium through the cooling units of these cooling structures to check thermal resistances and temperature differences between the main surface of the semiconductor module and coolant medium for comparison. It has been turned out upon the tests that the greater the thermal conductance and the smaller the temperature difference, the higher will be the cooling efficiency of the semiconductor module 7.

The tests have been conducted under a condition using the semiconductor element 71 with a size of 7.0 mm in height and width and the semiconductor module 7 including a main body with a size of 40 mm in height and 21 mm in width under which the semiconductor module 7 was operated with a calorific value of 600 W.

With the comparative cooling structure, the grease layer 11 was set to a thickness of 0.05 mm and the insulating plate 19 had a thickness of about 0.3 mm. With the cooling structure implementing the present invention, the grease layer 11 was set to a thickness of 0.05 mm and the Al—AlN composite material 1 had the AlN plate 2 with a thickness of 0.2 mm and the Al plate 3 with a thickness of 0.2 mm.

Under the condition mentioned above, the thermal resistance between the main surface 7a of the semiconductor module 7 and coolant medium was calculated. In case of the comparative cooling structure shown in FIG. 7, thermal resistance R1 was 0.104 K/W. In the resulting breakdown, thermal resistances R11 and R13 of the grease layers 11 were 0.05 K/W, respectively, and thermal resistance R12 of the insulating layer 19 was 0.004 K/W.

With the cooling structure of the present invention, on the contrary, thermal resistance R2 between the main surface 7a of the semiconductor module 7 and coolant medium was 0.054 K/W as shown in FIG. 8. In the resulting breakdown, thermal resistance R21 of the grease layer 11 was 0.05 K/W and thermal resistance R12 of the Al—AlN composite material 1 was 0.004 K/W.

Accordingly, it is turned out that the cooling structure of the present invention can achieve a reduction in thermal resistance between the semiconductor module 7 and the cooling tube 61 by an extent equivalent to thermal resistance of the grease layer 11.

Further, calculating the temperature difference between the main surface 7a of the semiconductor module 7 and coolant medium, the comparative cooling structure had the temperature difference in a value expressed as 600 W×0.104K/W=62° C. With the cooling structure of the present invention, on the contrary, the temperature difference had a value expressed as 600 W×0.054K/W=32° C.

Thus, it will be apparent that the cooling structure, employing the Al—AlN composite material 1 implementing the present invention, can cool the semiconductor module 7 at significantly increased efficiency.

### Embodiment 3

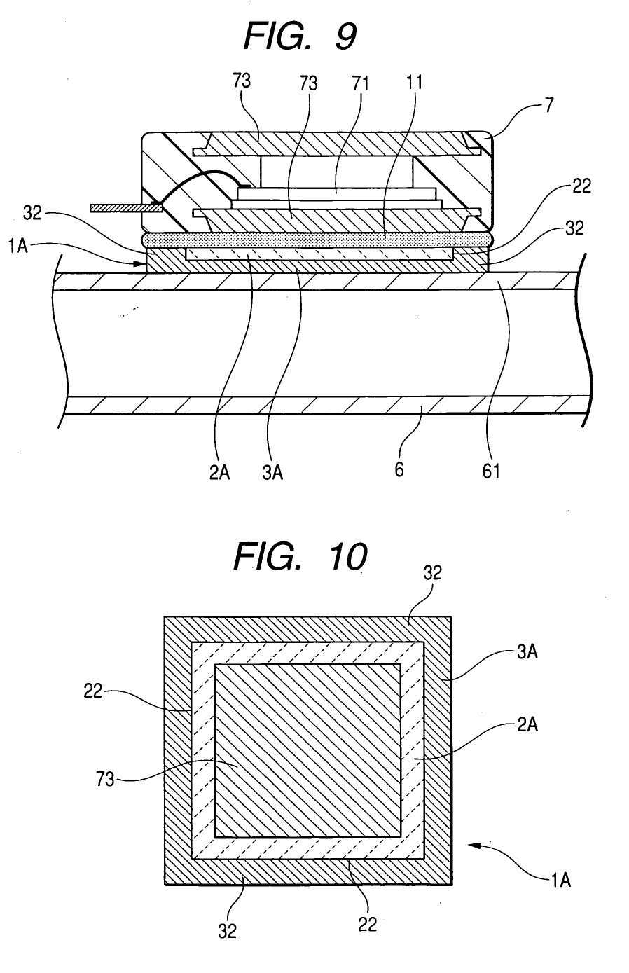

FIGS. 9 and 10 show a cooling structure incorporating an Al—AlN composite material 1A of a third embodiment according to the present invention that includes an Al plate 3A having an outer circumferential portion 32 that surrounds an end face 22 of the AlN plate 2.

As shown in FIG. 10, the Al—AlN composite material 1A includes an AlN plate 2A with a size covering the electrode plate 73 of the semiconductor module 7. The Al plate 3A, bonded to the AlN plate 2A, has the outer circumferential portion 32 formed on the Al plate 3A at an outer circumferential periphery thereof under a status surrounding and in contact with an outer periphery of the end face 22 of the AlN plate 2A.

The cooling structure of the present embodiment has the same other component parts as those of the first embodiment.

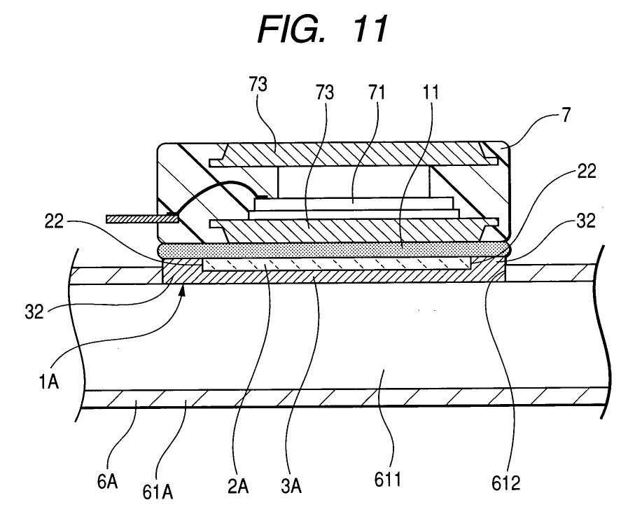

In FIG. 9, there is shown only the cooling unit 6 placed on one main surface of the semiconductor module 7 with the other cooling unit placed on the other main surface of the semiconductor module 7 being omitted for simplicity of illustration. In addition, this similarly applies to FIGS. 11, 15 and 19.

With the cooling structure of the present embodiment, the Al—AlN composite material 1A takes the form of a structure with the Al plate 3A holding the outer periphery of the AlN plate 2A. This prevents the AlN plate 2A from being damaged. In addition, even if a crack occurs in the AlN plate 2A, the Al plate 3A avoids the crack from expanding in the AlN plate 2A because the Al plate 3A holds the surrounding edge of the AlN plate 2A, enabling the suppression of a drop in electrically insulating property.

The cooling structure of the present embodiment has the same other advantageous effects as those of the first embodiment.

### Embodiment 4

FIG. 11 shows a cooling structure, incorporating the Al—AlN composite material 1A, of a fourth embodiment according to the present invention. The cooling structure includes a cooling unit 6A, composed of a cooling tube 61A, and the Al plate 3A forming part of the cooling tube 61A directly exposed to a coolant medium flow passage 611 extending through the cooling tube 61A.

That is, the Al—AlN composite material 1A is assembled to part of a tube wall of the cooling tube 61A to allow the Al plate 3A to form a part of the coolant medium flow passage 611.

In particular, the cooling tube 61A is partly formed with a circumferential opening portion 612, to which the Al—AlN composite material 1A is fitted to an end portion of the Al plate 3A, whose end face is connected to the surrounding tube wall of the cooling tube 61A at a circumferential periphery of the opening portion 612 by brazing.

The cooling structure of the present embodiment has the same other component parts as those of the third embodiment.

With the cooling structure shown in FIG. 11, the Al plate 3A is held in direct contact with cooling medium, enabling improved heat exchange efficiency to be obtained between the Al—AlN composite material 1A and coolant medium. This results in a capability of improving the heat exchange efficiency between a heating body (semiconductor module 7) and coolant medium.

### Embodiment 5

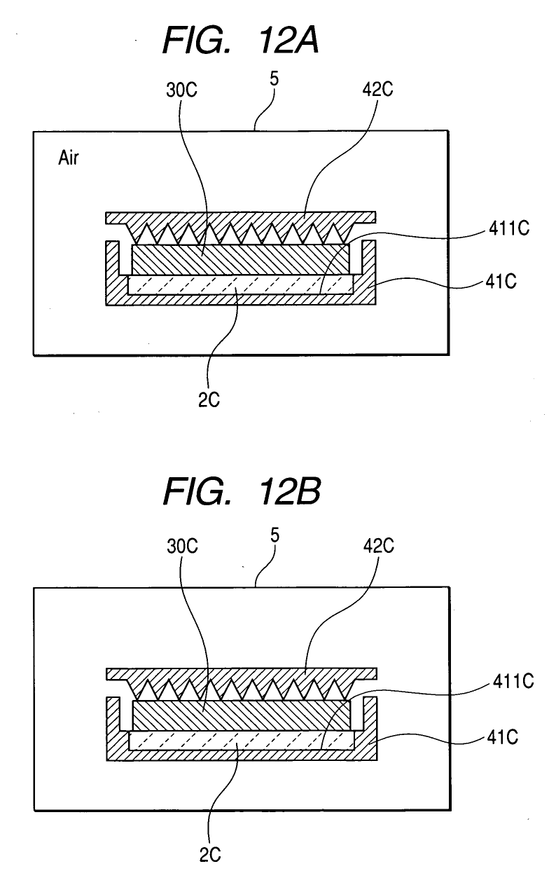

An Al—AlN composite material 1C of a fifth embodiment according to the present invention, a method of manufacturing the same and a cooling structure incorporating such an Al—AlN composite material 1C will be described below with reference to FIGS. 12A and 12B to FIGS. 14A and 14B and FIG. 15. With the fifth embodiment, the Al—AlN composite material 1C includes an AlN plate 2C and an Al plate 3C having one surface bonded to the AlN plate 2C at a bonding surface portion 3Ca and the other surface formed with a large number of cooling fins 33 extending upward in opposition to the bonding surface portion 3Ca.

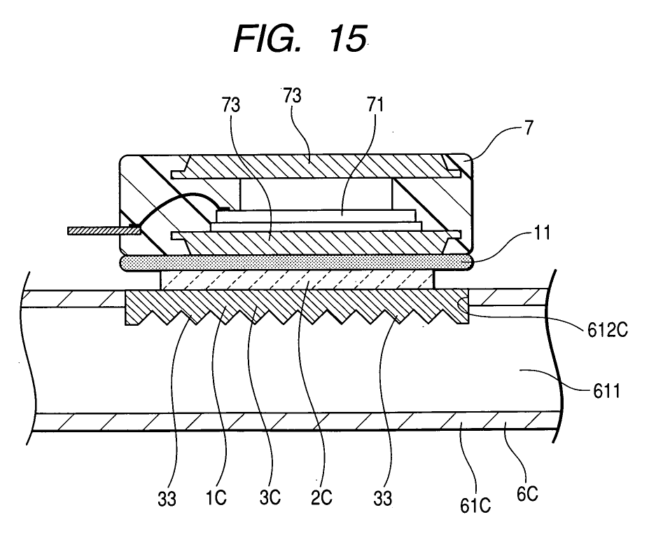

With the Al—AlN composite material 1C of the present embodiment, the Al plate 3C has the other surface formed with the large number of cooling fins 33 formed in a concaved and convexed pattern. As shown in FIG. 15, a part of a cooling tube 61C is formed with an opening portion 612C, to which the Al—AlN composite material 1C is fitted with an end portion of the Al plate 3C being brazed to a tube wall of the cooling tube 61C at a circumferential periphery of the opening portion 612C so as to allow the cooling fins 33 to be exposed to the coolant medium passage 611.

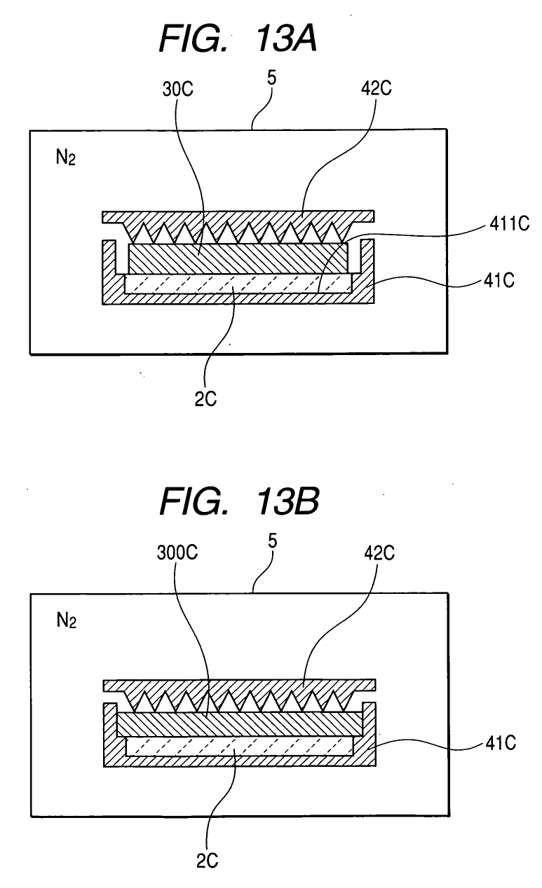

In manufacturing the Al—AlN composite material 1C of the present embodiment, as shown in FIGS. 12A and 12B, the AlN plate 2C is placed in a cavity 411C of a lower die 41C accommodated inside the chamber 5, after which a plate member 30C of aluminum is placed on the AlN plate 2C and the chamber 5 is subsequently evacuated. Then, as shown in FIG. 13A, a stream of nitrogen (N₂) gas is introduced to the chamber 5 for forming nitrogen gas atmosphere.

As shown in FIG. 13B, subsequently, the chamber 5 is heated, thereby causing the plate member 30C of aluminum to be melted. This causes melted aluminum 300C, resulting from the plate member 30C, to spread over a surface of the AlN plate 2C in an area within the cavity 411C of the lower die 41C.

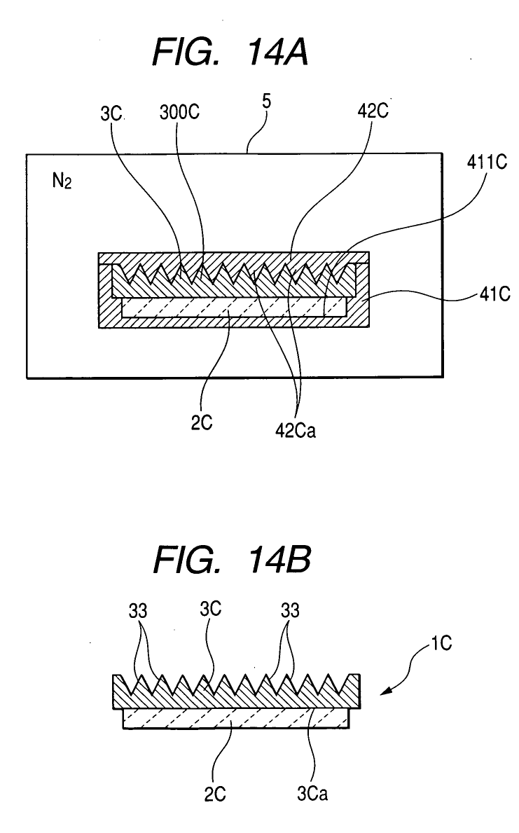

As shown in FIG. 14A, an upper die 42C is pushed against melted aluminum 300C to form the cooling fins 33 in a corrugated pattern as shown in FIG. 14B. That is, when melting aluminum on one surface of the Al plate 2C and spreading melted aluminum over the surface thereof after which melted aluminum is solidified, the upper die 42C, having one surface formed with a fin-like corrugated wall 42Ca, is pressed against the Al plate 3C such that the Al plate 3C is formed with the cooling fins 33.

Subsequently, the chamber 5 is cooled, thereby cooling the AlN plate 2C and melted aluminum 300C. This results in the solidification of melted aluminum 300C with the Al plate 3C being bonded to the surface of the AlN plate 2C.

Next, as shown in FIG. 14B, the Al—AlN composite material 1C, composed of the AlN plate 2C and the Al plate 3C, is taken out of the lower die 41C.

The manufacturing method of the present embodiment is carried out in the same other steps as those of the manufacturing method of the first embodiment.

As shown in FIG. 15, the Al—AlN composite material 1C of the present embodiment is fitted to an opening portion 612C of a cooling tube 6C to be exposed to a flow of coolant medium passing therethrough.

Using the Al—AlN composite material 1C of the present embodiment as part of a cooling unit 6C results in an increase in a contact surface area with coolant medium, enabling the provision of improved heat exchange efficiency.

Further, when melting aluminum on one surface of the Al plate 2C and spreading melted aluminum over the surface thereof after which melted aluminum is solidified, the upper die 42C, whose one surface is formed with the fin-like corrugated wall 42Ca, is pressed against the Al plate 3C to cause the Al plate 3C to be formed with the cooling fins 33. This enables the Al plate 3C to be easily formed with the cooling fins 33.

The Al—AlN composite material 1C of the present embodiment and related manufacturing method have the same advantageous effects as those of the Al—AlN composite material of the first embodiment and related manufacturing method.

### Embodiment 6

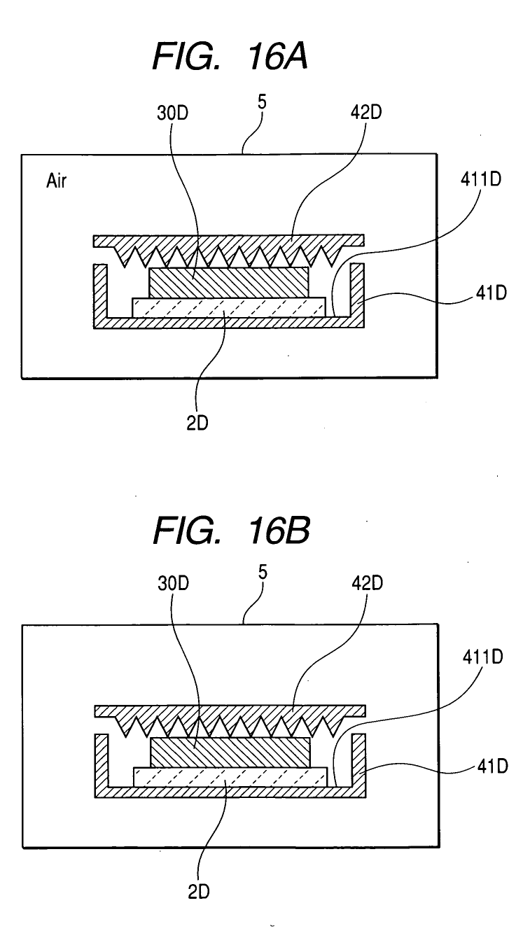

An Al—AlN composite material 1D of a sixth embodiment according to the present invention, a method of manufacturing the same and a cooling structure incorporating such an Al—AlN composite material 1D will be described below with reference to FIGS. 16A and 16B to FIGS. 18A and 18B and FIG. 19. With the sixth embodiment, the Al—AlN composite material 1D includes an AlN plate 2D and an Al plate 3D having one surface bonded to the AlN plate 2D at bonding surface portions 3Da and 3Db and the other surface formed with a large number of cooling fins 33D extending upward in opposition to the bonding surface portion 3Da.

With the Al—AlN composite material 1D of the present embodiment, the Al plate 3D has an outer circumferential portion 32 formed with the bonding surface portions 3Db surrounding end faces 22 of the AlN plate 2D.

That is, the Al—AlN composite material 1D of the present embodiment takes the form of a structure corresponding to a combined structure of the third and fifth embodiments.

In manufacturing the Al—AlN composite material 1D of the present embodiment, a lower die 41D is prepared with a structure having a cavity 411D larger in height and width than an AlN plate 2C as shown in FIG. 16A.

Then, as shown in FIG. 16A, the AlN plate 2D is placed in a central area of a bottom portion of the cavity 411D of the lower die 41D accommodated inside the chamber 5, after which a plate member 30D of aluminum is placed on the AlN plate 2D. Thereafter, the chamber 5 is evacuated in a manner as shown in FIG. 16B.

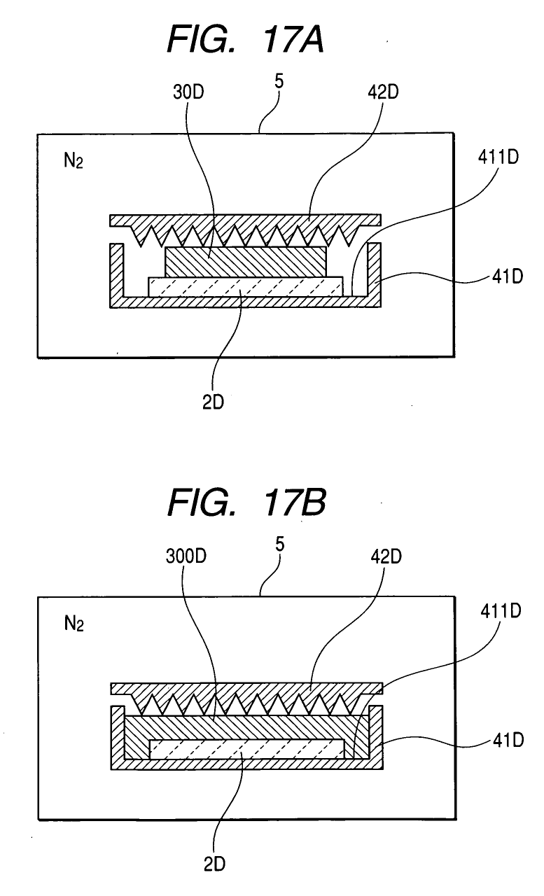

Then, as shown in FIG. 17A, a stream of nitrogen (N₂) gas is introduced into the chamber 5 for forming nitrogen gas atmosphere.

As shown in FIG. 17B, subsequently, the chamber 5 is heated, thereby causing the plate member 30D of aluminum to be melted. This causes melted aluminum 300D, resulting from the plate member 30D, to spread over a surface of the AlN plate 2D in an area within the cavity 411D of the lower die 41D.

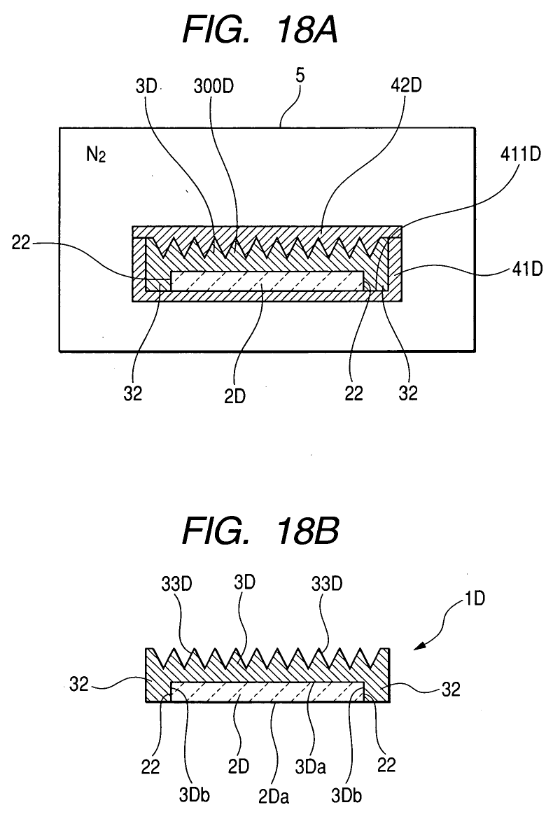

As shown in FIG. 18A, an upper die 42D is pushed against melted aluminum 300D to form the cooling fins 33D in a corrugated pattern as shown in FIG. 18B.

Subsequently, the chamber 5 is cooled, thereby cooling the AlN plate 2D and melted aluminum 300D. This results in the solidification of melted aluminum 300D with the Al plate 3D being bonded to the surface of the AlN plate 2D such that the outer circumferential portion 32 surrounds the an upper surface and end face 22 of the AlN plate 2D.

Next, as shown in FIG. 18B, the Al—AlN composite material 1D, composed of the AlN plate 2D and the Al plate 3D, is taken out of the lower die 41D.

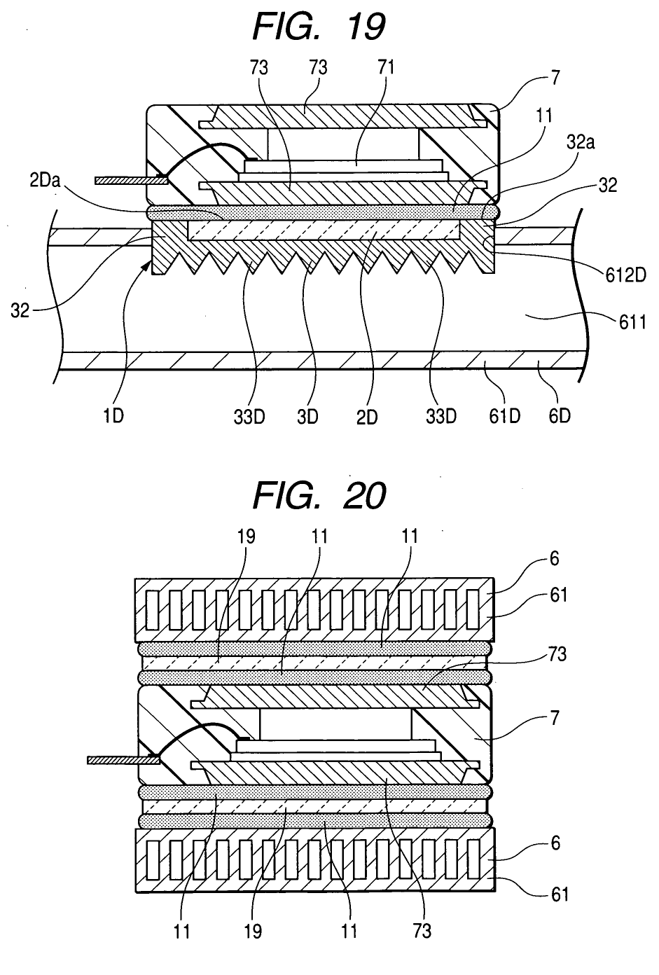

The Al—AlN composite material 1D, obtained in such a way mentioned above, is fitted to an opening portion 612D of a cooling tube 6D to be exposed to a flow of coolant medium passing therethrough such that the Al plate 3D forms a part of the coolant medium flow passage 611 as shown in FIG. 19. In addition, the Al—AlN composite material 1D is held in tight contact with the semiconductor module 7 via the grease layer 11 such that an end face of the Al plate 3D and one surface 2Da of the AlN plate 2D face the semiconductor module 7.

The manufacturing method of the present embodiment is carried out in the same other steps as those of the manufacturing method of the fifth embodiment.

The Al—AlN composite material 1D of the present embodiment and related manufacturing method have the same advantageous effects as those of the Al—AlN composite material of the third and fifth embodiments and related manufacturing method.

While the specific embodiment of the present invention has been described in detail, it will be appreciated by those skilled in the art that various modifications and alternatives to those details could be developed in light of the overall teachings of the disclosure. Accordingly, the particular arrangement disclosed is meant to be illustrative only and not limited to the scope of the present invention, which is to be given the full breadth of the following claims and all equivalents thereof.

What is claimed is:

1. An Al—AlN composite material comprising:
an Al plate made of aluminum; and
an AlN plate made of aluminum nitride;
wherein aluminum is melted and flows over one surface of the AlN plate under inactive gas atmosphere after which melted aluminum is solidified to form the Al plate bonded to the AlN plate.

2. The Al—AlN composite material according to claim 1, wherein:
the Al plate has one surface formed with beat-dissipating configurations in opposition to the other surface of the Al plate bonded to the AlN plate.

3. An Al—AlN composite material comprising:
an Al plate made of aluminum and having one surface formed with heat-dissipating configurations; and
an AlN plate made of aluminum nitride and bonded to the other surface of the Al plate.

4. The Al—AlN composite material according to claim 3, wherein:
the Al plate has an outer circumferential portion covering an end of the AlN plate.

5. A heat exchanger including the Al—AlN composite material according to claim 3, wherein:
the AlN plate is held in thermal contact with a heating body.

6. The heat exchanger according to claim 5, comprising:
a coolant medium flow passage admitting a flow of coolant medium available to perform heat exchange with the heating body;
wherein the Al plate forms at least a part of the coolant medium flow passage.

7. The heat exchanger according to claim 5, wherein:
the heating body includes an electronic component part.

8. The heat exchanger according to claim 7, wherein:
the heat exchanger comprises a cooling unit for cooling a semiconductor module forming an electric power converter device.

9. A method of manufacturing an Al—AlN composite material, the method comprising:
melting aluminum in an area over one surface of an AlN plate under inactive gas atmosphere;
flowing melted aluminum in the area over the one surface of the AlN plate under inactive gas atmosphere;
placing a forming die on a layer of melted aluminum present on the one surface of the AlN plate; and
solidifying the layer of melted aluminum to form an Al plate bonded to the AlN plate.

10. The method of manufacturing an Al—AlN composite material according to claim 9, wherein:
the forming die has one surface, facing the AlN plate, which is formed with a corrugated surface;
whereby when the forming die is placed on the layer of melted aluminum present on the one surface of the AlN plate, the Al plate is formed with heat-dissipating configurations in conformity with the corrugated surface of the forming die.

11. A heat exchanger for cooling a heating body, comprising:
a cooling tube; and
an Al—AlN composite material interposed between the heating body and the cooling tube to initiate a heat exchange between the heating body and the cooling tube;
wherein the Al—AlN composite material comprises an Al plate, made of aluminum and having one surface formed with a heat dissipating surface associated with the cooling tube, and an AlN plate made of aluminum nitride and bonded to the other surface of the Al plate upon melting aluminum on the AlN plate under inactive gas atmosphere after which melted aluminum is solidified.

12. The heat exchanger according to claim 11, wherein:
the heat dissipating surface is formed with heat-dissipating configurations.

13. The heat exchanger according to claim 11, wherein:
the Al plate has an outer circumferential portion covering an end of the AlN plate.

14. The heat exchanger according to claim 11, wherein:
the AlN plate is held in thermal contact with the heating body.

15. The heat exchanger according to claim 11, wherein:
the cooling tube comprises a coolant medium flow passage admitting a flow of coolant medium available to perform heat exchange with the heating body;
wherein the Al plate forms at least a part of the coolant medium flow passage.

16. The heat exchanger according to claim 11, wherein:
the heating body includes an electronic component part.

17. The heat exchanger according to claim 11, wherein:
the heating body comprises a semiconductor module forming an electric power converter device.
